(19) United States
(12) Patent Application Publication
(10) Pub. No.: US 2009/0220600 A1
(43) Pub. Date: Sep. 3, 2009

(54) ANTIMICROBIAL FILMS

(76) Inventors: Ivan Parkin, Milton Keynes (GB); Michael Wilson, London (GB); Kristopher Page, Longfield (GB)

Correspondence Address: NIXON & VANDERHYE, PC, 901 NORTH GLEBE ROAD, 11TH FLOOR, ARLINGTON, VA, 22203, US

(21) Appl. No.: 12/091,713

(22) PCT Filed: Oct. 30, 2006
(86) PCT No.: PCT/GB2006/004036

§ 371 Date: Aug. 22, 2008

(30) Foreign Application Priority Data
Oct. 31, 2005 (GB) 0522238.5
Feb. 21, 2006 (GB) 0603431.8

(51) Int. Cl. A01N 25/34; A01N 59/16; A01P 1/00

(52) U.S. Cl. 424/484; 424/618

(57) ABSTRACT

A film consisting of a titanium dioxide host matrix comprising silver oxide nanoparticles.

The present invention relates to films comprising silver oxide nanoparticles in a titanium dioxide host matrix. The invention also relates to a process for the production of such films, and to their use in antimicrobial applications.

### BACKGROUND

Nanocomposite films comprising silver nanoparticles in a titanium dioxide host matrix are known. Such films have found application as photocatalysts. Other metal dopants, such as platinum, have also been used.

Previous silver nanoparticle/titanium dioxide films have been prepared under argon, i.e. in an inert atmosphere. The present inventors have found that preparation in air yields silver oxide nanoparticle/titanium dioxide films, and that surprisingly these films have antimicrobial properties.

### SUMMARY OF THE INVENTION

In one aspect of the invention there is provided a film comprising silver oxide nanoparticles in a titanium dioxide host matrix. In particular, the present invention relates to a film consisting of a titanium dioxide host matrix comprising silver oxide nanoparticles.

The invention also provides a process for producing the film by depositing silver metal or silver alloy nanoparticles and a titanium dioxide film under conditions in which the silver is oxidised, or by treating films of titanium dioxide containing silver nanoparticles under conditions whereby silver may be oxidised, or by depositing silver oxide nanoparticles and a titanium dioxide film.

Without wishing to be bound by theory, the present inventors believe that silver nanoparticles oxidised during or after production of the film, or silver oxide nanoparticles used in production of the films, serve to stabilise electron/positive hole pairs generated by irradiation of the titanium dioxide. Such electron/positive hole pairs are then available to react with surface bound species, such as water, to form reactive radicals such as the hydroxyl radical and singlet oxygen. These radicals are responsible for exerting the antimicrobial effect of the films. X-ray diffraction (XRD) shows a peak corresponding to the main diffraction signal of silver oxide in those active films that have so far been investigated. It is therefore believed that it is the presence of silver oxide that is responsible for the beneficial effect of the films. However, the XRD peak may be due to components other than silver oxide. Whilst associated with the effect, neither the XRD peak nor the presence of silver oxide have been conclusively verified as essential to the effect. The active films are however always obtained by deposition of silver nanoparticles under oxidising conditions or where films have been treated by annealing. By “silver oxide” as used herein, we mean the result of deposition of silver nanoparticles under oxidising conditions or where films have been treated by annealing.

In another aspect, the present invention provides use of the films as antimicrobials.

### DETAILED DESCRIPTION OF THE INVENTION

The films of the present invention may be produced by depositing silver nanoparticles and a titanium dioxide film under conditions in which the silver is oxidised, or by depositing silver oxide nanoparticles and a titanium dioxide film.

For example, the films may be prepared using a sol-gel dip coating technique, or by aerosol assisted chemical vapour deposition (AACVD). In a preferred aspect, the films are produced other than by AACVD.

As used below, the term “silver nanoparticle” is intended to include nanoparticles of silver metal, a silver metal alloy, oxidised silver or silver alloy or silver oxide nanoparticles. The term “silver metal or silver alloy nanoparticles” refers to those which have not yet been oxidised. The “silver nanoparticles” in the final product must contain at least some silver oxide and are referred to herein as “silver oxide nanoparticles”. Preferably, the nanoparticles comprise a core of silver or silver alloy surrounded by a layer of the oxide. Alternatively, the nanoparticles may consist entirely of silver oxide.

The silver alloy nanoparticles may be, for example, commercially available silver alloy nanoparticles, for instance comprising copper or metals of Group VIII of the Periodic Table and precious metals such as gold, palladium, platinum, rhodium, iridium or osmium.

As used herein, the term “film” is intended to refer to a contiguous layer of titanium dioxide. Such films (especially when relatively thick) may be subject to shrink-cracking, such that they are not completely continuous on a microscopic scale. When formed by a vapour phase deposition process, the titania layer grows from many seed points and thus the film will contain separate domains or “islands” of titanium dioxide with boundaries between such domains. The films nevertheless appear continuous on a macroscopic scale. They are clearly distinct from particulate or nanoparticulate titanium dioxide. Silver oxide nanoparticles are deposited in or upon the titanium dioxide film.

When preparing a nanocomposite film, the concentration of silver nanoparticles in the precursor solution is preferably such that the deposited titanium dioxide host matrix comprises 1 to 4% of the silver nanoparticles. In another embodiment, the deposited film comprises 0.1 to 20 mol % or even up to 25 mol % of silver oxide nanoparticles, preferably 5 to 10 mol %, for example 5 mol %. The film may optionally comprise components other than the titanium dioxide and silver oxide nanoparticles. In a preferred form the film consists of from 5 to 10 mol % silver oxide nanoparticles and 95 to 90 mol % titanium dioxide.

Sol Gel Deposition

In the sol-gel process a silver nanoparticle suspension is produced by conventional methods except that a source of oxygen may be provided, or the process may be conducted in the presence of air. This affords nanoparticles at least the surfaces of which are primarily silver oxide. Oxidation may extend throughout the particles. Dip coating of a substrate in the suspension, once or perhaps several times, for instance up to five times, followed by annealing, forms the nanoparticulate film. The annealing step may also cause or increase the oxidation of the silver nanoparticles.

Films may be prepared by first dip-coating with a titanium dioxide precursor solution and then dip-coating with a silver nanoparticle suspension. Alternatively, the silver nanoparticle suspension and titanium dioxide precursor solutions can be mixed before dip-coating, thereby forming the film consisting of a titanium dioxide host matrix comprising silver oxide nanoparticles directly. Suitable titanium dioxide precursor solutions comprise 250 to 500 g L⁻¹ of the titanium dioxide precursor, preferably 300 to 400 g L⁻¹. Silver nanoparticle precursor solutions may suitably comprise 300 to 800 g L⁻¹ of the silver nanoparticle precursor, preferably from 500 to 700 g L⁻¹. The silver nanoparticle precursor solution is then added to the titanium dioxide precursor solution such that the mixed solution typically contains 250 to 500 g L⁻¹, preferably 300 to 400 g L-¹ of the titanium dioxide precursor and 5 to 30, preferably around 10 to 20 g L⁻¹ of the silver nanoparticle precursor. Since dispersions of nanostructures in precursor solutions tend to become unstable at concentrations above 10 g L⁻¹, such solutions should preferably be used within 24 hours to avoid precipitation of silver.

Typical molar ratios of the silver nanoparticles to the amount of titanium dioxide host matrix precursor are from 1:1000 to 1:4. Preferably, the ratio of silver nanoparticles to titanium dioxide host matrix precursor is from 1:30 to 1:5, more preferably from 1:20 to 1:10.

The solvent in which the silver nanoparticles are suspended before dip coating is preferably one which is suitable for complexing with the silver, e.g. providing a coordinating ligand, preferably nitrogen-containing solvents such as acetonitrile, propylnitrile or benzonitrile. Other chelating nitrogen-type bases such as bipyridine, terpyridyl and phenanthroline would also be suitable, as would chelating oxygen donor ligands such as glycols and polyethers. Preferably, the solvent in which the silver nanoparticles are suspended before dip coating comprises acetonitrile. More preferably, the solvent in which the silver nanoparticle precursor is suspended prior to mixture with the titanium dioxide precursor consists of acetonitrile. Use of this solvent affords adhesive, adherent coatings.

AACVD Deposition

In the AACVD process a precursor solution containing silver nanoparticles is used. These may be formed by conventional methods or, as in the sol-gel process, may be formed under oxidising conditions such that at least the surface of the particles is primarily silver oxide and optionally the silver is oxidised throughout the nanoparticle.

Alternatively, silver nanoparticles which have been produced without oxidation, for example under an inert atmosphere, may be used in the precursor solution. In this case residual oxygen in the apparatus, other reagents or the substrate is sufficient to oxidise the silver at least at the surface of the nanoparticles.

The precursor solution is then any solution comprising silver nanoparticles. Such a precursor solution for providing silver nanoparticles for deposition may be prepared according to any suitable technique. A well-known technique for the production of nanoparticles is reduction in solution. For example, a metal colloid solution comprising metal nanoparticles may be prepared by the Brust two-phase reduction method, which was initially described for use in preparing gold metal colloids, and has since been extended to the production of nanoparticles of other metals.

The precursor solution also comprises a titanium dioxide host matrix precursor. The titanium dioxide host matrix precursor solution may be any suitable to deposit titanium dioxide. Preferred precursors are titanium complexes having at least one ligand selected from alkoxide, aryloxide, CO, alkyl, amide, aminyl, diketones.

Suitable ligands comprise a group R attached to oxygen, which is to be incorporated in the deposited host matrix. It is preferred that the group R is short, for example C₁₋₄, or has a good leaving functionality.

Examples of alkoxide ligands are C₁₋₆ alkoxide such as ethoxide, preferably C₁₋₄ alkoxide most preferably isopropyloxide (OⁱPr) or tertiary-butyloxide (O^{t}Bu). The aryloxide is preferably substituted or unsubstituted phenoxide, preferably unsubstituted phenoxide. Examples of alkyl groups are C₁₋₄ alkyl, such as methyl and ethyl. Examples of amide are R¹CON R²₂, where each R¹ and R² is each independently H or C₁₋₄ alkyl. Examples of aminyl are N R¹₂ where R¹ is as defined above. Examples of diketones include pentane-2,4-dione.

Preferably, all ligands are selected from these groups. Most preferably, the coordination sphere around the metal contains all oxygen.

Suitable ligands may contain oxygen, for incorporation in the deposited titanium dioxide host matrix. Alternatively, the titanium dioxide host matrix precursor may be used with a co-source of oxygen, such as an alcohol solvent or oxygen.

Preferred examples of the host matrix precursor include titanium (IV) isopropoxide ([Ti(OⁱPr)₄]).

Any suitable solvent may be used for the precursor solution, preferably an organic solvent, although water may be used. Preferably, the solvent is propan-2-ol, toluene, benzene, hexane, cyclohexane, methyl chloride or acetonitrile. Two or more different solvents may be used, provided the solvents are miscible.

The concentration of silver nanoparticles in the deposited film can be altered simply by changing the concentration of silver nanoparticles in the precursor solution. The concentration of silver nanoparticles in the precursor solution may vary from 1 μg L⁻¹ to 10 g L⁻¹. The lower concentration of silver nanoparticles would normally be used together with higher concentrations of a titanium dioxide host matrix precursor to provide a nanocomposite film comprising very low (i.e. dopant) levels of the silver particles. At concentrations above 10 g L⁻¹, dispersions of nanostructures in precursor solutions tend to become unstable.

Preferably, the concentration of silver nanoparticles in the precursor solution is from 0.5 to 1.5 g L⁻¹, more preferably from 0.7 to 1.0 g L⁻¹. When preparing a nanocomposite film, the concentration of silver nanoparticles in the precursor solution is preferably such that the deposited titanium dioxide host matrix comprises 1 to 4% of the silver nanoparticles. In another embodiment, the deposited film comprises 0.1 to 20 mol % or even up to 25 mol % of silver oxide nanoparticles, preferably 5 to 10 mol %, for example 5 mol %. The film may optionally comprise components other than the titanium dioxide and silver oxide nanoparticles. In a preferred form the film consists of from 5 to 10 mol % silver oxide nanoparticles and 95 to 90 mol % titanium dioxide.

The molar ratio of the silver nanoparticles to the amount of titanium dioxide host matrix precursor may be from 1:1000 to 2:1. Typical molar ratios of the silver nanoparticles to the amount of titanium dioxide host matrix precursor are from 1:30 to 1:5. Preferably, the ratio of silver nanoparticles to titanium dioxide host matrix precursor is from 1:3 to 1:10.

Preferably, silver nanoparticle precursor solutions are charge-stabilized in order to prevent aggregation of the nanostructures. In principle, capping groups, such as thiol capping groups, may be used. This is not preferable, however, since it may lead to contamination of the deposited films.

Since silver nanoparticle solutions in solvents other than water degrade over time, it is preferable to use such solutions within three weeks of preparation. More preferably, the solutions are used within one week of preparation, more preferably within 2 days. Most preferably, depositions are carried out using colloids made on the same day.

Annealing

The process of the invention may comprise a further step of annealing the film. Annealing is known to increase film density by eliminating pores and voids, and thus would be expected to reduce particle separation. For films prepared using a sol-gel dip coating technique, annealing serves to obtain crystalline films by decomposition of the sol-gel precursors. When sols contain nanoparticles, the heat treatment also removes the residual organic compounds used to chelate and stabilise the nanoparticles.

The time and temperature of annealing depends on the substrate. Typically, films may be annealed by heating in air at a temperature of from 300 to 700° C., preferably 400 to 600° C., more preferably 450 to 550° C., for between 20 minutes and 2 hours.

The annealing step will often serve to oxidise silver in silver metal or silver alloy nanoparticles to produce silver oxide nanoparticles, using traces of oxygen in impurities, residual moisture or other components of the film.

In one embodiment of the invention, instead of a post-annealing step, the precursor solution is applied to a heated substrate surface so that annealing is, effectively, carried out simultaneously with deposition. This embodiment is, for example, appropriate where the film is applied by aerosol deposition. In this embodiment, the substrate surface is typically pre-heated to a temperature of from 300 to 700° C., preferably 400 to 600° C., more preferably 450 to 550° C. Lower pre-heating temperatures are also envisaged, for example from 50° C. to 300° C., preferably from 100° C. to 300° C.

Substrate

Provided the substrate is capable of having a film deposited on its surface, the substrate is not critical to the invention. The substrate may be, for example, a glass substrate, for example glass slides, films, panes or windows. Glass substrates may have a barrier layer of silicon dioxide (SiO₂) to stop diffusion of ions from the glass into the deposited film. Typically, the silicon dioxide (SiO₂) barrier layer is 50 nm thick.

Preferred substrates are temperature-insensitive materials such as metals, metal oxides, nitrides, carbides, suicides and ceramics. Such substrates may be, for example, in the form of windows, tiles, wash basins or taps.

The films of the present invention preferably have a thickness of from 25 to 1000 nm, preferably from 50 to 500 nm, more preferably from 100 to 400 nm.

Antimicrobial Effect

The films of the present invention have an antimicrobial effect, i.e. they are capable of destroying or inhibiting the growth of microorganisms. They may also be effective against agents such as prions.

The antimicrobial effect of the films is activated by exposure to a light source. In one embodiment, the films may be exposed to a light source comprising radiation having a wavelength, or a range of wavelengths, within or corresponding to the bandgap of the titanium dioxide in the film. In general, radiation having wavelength(s) of 385 nm, preferably 380 nm, or lower is preferable. For example, sunlight, approximately 2% of which is radiation of 385 nm or lower wavelength, is a suitable light source. Exposure to ambient lighting, such as indoor lighting, is also sufficient to provide the antimicrobial effect, provided the light source is not covered in plastic or other material such that radiation having a wavelength less than or equal to the titanium dioxide bandgap is absorbed or prevented from reaching the film.

Particularly effective films of the present invention have very low contact angles, providing surfaces with good wettability. Surfaces coated with such films therefore have good drainage properties and are suitable for self-cleaning applications. Preferred films are superhydrophilic, having contact angles of 10° or less, even of zero.

The self-cleaning/antimicrobial properties of the films of the present invention may find application in hospitals and other places where microbiological cleanliness is necessary, for example food processing facilities, dining areas or play areas. Use in abattoirs is also envisaged. The films may be applied to any suitable surface in order to provide antimicrobial properties, for example metal surfaces such as taps and metal work surfaces, ceramic surfaces, such as wash basins and toilets or glass surfaces, such as doors and windows. It is also envisaged that the films could be applied to furniture, such as beds, or medical equipment and instruments. Preferred applications of the films are surfaces for use in a medical environment, such as tiles, work surfaces, door handles, taps and beds. In one aspect, the present invention does not extend to the use of the films in methods of treatment of the human or animal body by surgery or therapy, or in methods of diagnosis conducted on the human or animal body.

### EXAMPLES

### Example 1

TiO₂ Films: Titanium isopropoxide [Ti(OCH(CH₃)₂)₄] (6 cm³, 0.02 mol) was added to 50 cm³ propan-2-ol. Hydrochloric acid 2M (0.2 cm³) was then added to this solution dropwise from a graduated syringe. The solution was then stirred vigorously for an hour. The resultant colourless and slightly opaque solution was then covered and left to age overnight. After ageing overnight, the appearance of the sol was unchanged, and no precipitation was observed.

10% silver oxide (e.g. Ag₂O or AgO) doped titanium dioxide (TiO₂) Film: This synthesis follows the method of Epifani et al [Epifani, M., Giannini, C., Tapfer, L. and Vasanelli, L. Journal of the American Ceramic Society, 83 [10], (2000) 2385-93], except that the procedure was carried out in air to allow oxidation of the silver nanoparticles. Titanium n-butoxide (17.02 g, 0.05 mol) was chelated with a mixture of pentane-2,4-dione (2.503 g, 0.025 mol) in butan-1-ol (32 cm³, 0.35 mol). A clear, straw yellow solution was produced, with no precipitation. This was covered with a watch glass and stirred for an hour. Distilled water (3.6 g, 0.2 mol) was dissolved in propan-2-ol (9.04 g, 0.15 mol) and added to hydrolyse the titanium precursor. The solution remained a clear straw yellow colour, with no precipitate. The solution was stirred for a further hour. Silver nitrate (0.8510 g, 0.005 mol) was dissolved in acetonitrile (1.645 g, 0.04 mol). This was added to the pale yellow titanium solution, which was stirred for a final hour. After the final stirring, the resultant sol was a slightly deeper yellow in colour, but remained clear and without precipitate. The sol was used within 30 minutes for dip-coating, as precipitation of silver occurs within 24 hours.

Dip-Coating

The films were prepared on standard low iron microscope slides (BDH). These were supplied cleaned and polished, but were nonetheless washed with distilled water, dried and rinsed with propan-2-ol and left to air dry before use. For dip-coating the glass microscope slides, the aged sols were transferred to a tall and narrow 50 cm³ beaker to ensure that most of the slide could be immersed in the sol. A dip-coating apparatus was used to withdraw the slide from the sol at a steady rate of 120 cm min⁻¹. If more than one coat was required, the previous coat was allowed to dry before repeating the process.

All films were annealed in a furnace at 500° C. for one hour, with a rate of heating and cooling of 5° C. min⁻¹.

Antibacterial Activity

The antibacterial activity of the films was assessed against Staphylococcus aureus (NCTC 6571), Escherichia coli (NCTC 10418) and Bacillus cereus (CH70-2). Samples were tested in duplicate against a suite of controls (detailed below). Sample coatings and the controls were irradiated under a 254 nm germicidal UV lamp (Vilber Lourmat VL-208G from VWR Ltd) for 30 minutes to both activate and disinfect the films. The sample slides were then transferred to individual moisture chambers (made from Petri dishes with moist filter paper in the base). An overnight culture in nutrient broth (Oxoid) was then vortexed and 25 μl aliquots of the culture pipetted on to each film in duplicate. The samples were then irradiated by a black light blue UV lamp, 365 nm (Vilber Lourmat VL-208BLB from VWR Ltd) for the desired length of time in order to inactivate the bacterial overlayer. After the desired inactivation period, the bacterial droplets were swabbed from the surface using sterile calcium alginate swabs. The swabs were transferred aseptically to 4 ml calgon ringer solution (Oxoid) in a glass bijoux containing 5-7 small glass beads. The bijoux was then vortexed until the entire swab had dissolved. For all bijoux, serial 10-fold dilutions of the bacterial suspension were prepared down to 10⁻⁶ in phosphate buffered saline (Oxoid). Each dilution was then plated in duplicate onto agar. Mannitol salt agar (Oxoid) was used for S. aureus, MacConkey agar (Oxoid) was used for E. coli and nutrient agar (Oxoid) was used for B. cereus. Inoculated plates were then incubated overnight at 37° C. After incubation, a colony count was performed for the dilution with the best countable number of colonies (30 to 300 colonies). The data were then processed, taking into account the dilution factor and the mean values of duplicate experiments. The end result is a direct comparison of the number of bacteria per millilitre on the samples to that on a glass control. Experiments were repeated at least twice, giving four data points for each sample tested.

Appropriate use of controls is essential in determining whether the coating by itself, UV exposure by itself, or a combination of the two is the cause of any observed bactericidal effect. For each coating under test (i.e. active substrate in UV light; L+S+), the following system of positive and negative controls was required: inactive substrate in UV light (L+S−); active substrate in the dark (L−S+); inactive substrate in the dark (L−S−). “Inactive substrate” refers to an uncoated glass slide.

Staphlylococcus aureus (NCTC 6571)

Experiments on S. aureus were carried out using irradiation times of 2 h, 4h and 6 h. Both the silver oxide (e.g. Ag₂O or AgO) or doped and un-doped titanium dioxide (TiO₂) coatings displayed antibacterial activity towards S. aureus, although to varying degrees (Table 3). A two coat silver oxide (e.g. Ag₂O or AgO/titanium dioxide (TiO₂) coating proved to be extremely effective against S. aureus, being 99.997% effective against an inoculum of approximately 1.33×10⁷ cfu/ml S. aureus after 6 h of illumination under 365 nm UV light. A four coat titanium dioxide (TiO₂) coating displayed an effectiveness of 49.925% against the same inoculum.

TABLE 3
Antibacterial activity of nanoparticle
coating compared with controls.

| | Irradiation | S. aureus |
|---|---|---|
| Sample | time (hrs) | (cfu/ml) |
| Two coat silver oxide (e.g. | 2 | 7300000 |
| Ag₂O or AgO)/titanium | 4 | 2420000 |
| dioxide (TiO₂) coating (L+S+) | 6 | 370 |
| Four coat titanium dioxide | 2 | 15900000 |
| TiO₂ coating (L+S+) | 4 | 8080000 |
| | 6 | 6690000 |
| Control (L+S−) | 2 | 13000000 |
| | 4 | 15000000 |
| | 6 | 7180000 |
| Control (L−S−) | 2 | 11500000 |
| | 4 | 14800000 |
| | 6 | 13400000 |

The supplementary studies carried out at 2 h and 4 h of irradiation enabled elucidation of relative antimicrobial activity between coating types, and also of the relationship between UV light dose and antimicrobial activity. Examination of the data with irradiation time taken into consideration shows a typical dose-response relationship between UV dose and antimicrobial activity. The level of overall effectiveness was greater for the silver oxide (e.g. Ag₂O or AgO) doped coating, and this had a faster rate of disinfection against S. aureus than the reference titanium dioxide (TiO₂) coating.

The comparative efficacy of all tested coatings against S. aureus is shown in Table 4. An irradiation time of 4 h was used to make this assessment since this time is insufficient for a complete inactivation of the inoculum, even with the most active coating. This therefore yields comparative data for the relative effectiveness of each coating type towards S. aureus.

TABLE 4
Comparison of coating effectiveness against S. aureus
(cfu/ml) using a 4 h irradiation time.

| | S. aureus | |
|---|---|---|
| Sample | (cfu/ml) | % Kill |
| Control (L−S−) silver oxide | 14900000 | — |
| (e.g. Ag₂O or AgO)/ | | |
| titanium dioxide (TiO₂) | | |
| Two coat silver oxide (e.g. | 2420000 | 83.7 |
| Ag₂O or AgO)/titanium | | |
| dioxide (TiO₂) | | |
| Three coat silver oxide | 3970000 | 73.3 |
| (e.g. Ag₂O or AgO)/ | | |
| titanium dioxide (TiO₂) | | |
| Four coat silver oxide (e.g. | 8140000 | 45.3 |
| Ag₂O or AgO)/titanium | | |
| dioxide (TiO₂) | | |
| Four coat titanium dioxide | 8080000 | 45.7 |
| (TiO₂) | | |

Table 4 clearly demonstrates the variation in antimicrobial effectiveness between coating types. For the silver oxide (e.g. Ag₂O or AgO-doped films, the effectiveness was of the order 2 coat>3 coat>4 coat, with the 4 coat silver oxide (e.g. Ag₂O or AgO)/titanium dioxide (TiO₂) and titanium dioxide (TiO₂) film being of similar effectiveness. The most successful coating was a thin (two coat) silver oxide (e.g. Ag₂O or AgO)-doped film.

Escherichia coli (NCTC 10418)

Six hour experiments were carried out with a two coat silver oxide (e.g. Ag₂O or AgO)/titanium dioxide (TiO₂) coating against E. coli. The coating averaged an effectiveness of 69% against an inoculum of ca. 1.6×10⁷ cfu/ml E. coli, compared to an effectiveness of 52% for an uncoated slide exposed to UV light for the same irradiation time.

Bacillus cereus (CH70-2)

The two coat silver oxide (e.g. Ag₂O or AgO)/titanium dioxide (TiO₂) coating was also tested against B. cereus, a Gram-positive, spore-forming organism. The coating achieved 99.9% kills of this organism after an irradiation time of 2 h, maintaining this level of effectiveness after 4 h. The initial concentration of B. cereus was approximately 7.46×10⁵ cfu/ml B. cereus. This demonstrates that the coating was extremely effective after just 2 h against an inoculum in the region of one million cfu/ml. The success of the coating against this level of bacterial contamination is further evidence for its potential use as an antimicrobial coating in a hospital environment.

5% Silver Oxide (e.g. Ag₂O or AgO) Doped Titanium Dioxide (TiO₂) Film:

A two coat silver oxide (e.g. Ag₂O or AgO/titanium dioxide (TiO₂) film was prepared as described above, except that the amount of silver precursor was adjusted such that the deposited film comprised 5% of the silver oxide. The antibacterial activity of the film was assessed against Staphylococcus aureus against a suite of controls as described above, using 40 μl aliquots with an irradiation time of 6 hours.

Due to the superhydrophilic nature of the films, it was necessary to contain the bacterial culture aliquots on the film such that the sample droplets did not run off the edges of the glass slide. Three different containment methods were used, as detailed in Table 5 below. The 5% doped films showed excellent kills, as shown in Table 5.

TABLE 5
Antibacterial activity of 5% silver oxide
(e.g. Ag₂O or AgO)/titanium dioxide (TiO₂)
coating compared with controls.

| | Containment | S. aureus | |
|---|---|---|---|
| Sample | method | (cfu/ml) | % kill |
| Two coat 5% silver oxide | Grease ring | 210 | >99 |
| (e.g. Ag₂O or AgO/titanium | Chinagraph | 910 | >99 |
| dioxide (TiO₂)coating (L+S+) | Marker pen | 996000 | 93 |
| Control (L−S+) | Grease ring | 2090000 | 83 |
| | Chinagraph | 2550000 | 66 |
| | Marker pen | 6880000 | 52 |
| Control (L+S−) | Grease ring | 4160000 | 67 |
| | Chinagraph | 4200000 | 45 |
| | Marker pen | 5090000 | 64 |
| Control (L−S−) | Grease ring | 12500000 | — |
| | Chinagraph | 7640000 | — |
| | Marker pen | 14300000 | — |

L+ = with irradiation;
L− = without irradiation;
S+ = with coated film;
S− = without coated film.

When initial experiments were performed, “silver oxide” was referred to as “AgO”. Subsequent experiments established that the oxide involved was in fact Ag₂O.

### Example 2

### Further Characterisation of Materials

Scanning Electron Microscopy (SEM), Wavelength Dispersive Analysis of X-rays (WDX), X-ray photoelectron spectroscopy (XPS) and X-ray Absorption near edge structure (XANES) have been carried out. These techniques have enabled elucidation of the silver oxide species which is present in these films.

SEM/WDX

SEM and WDX techniques were used to study the composition and morphology of the coated surfaces. WDX analysis confirmed the presence of Ag in the Ag/TiO₂ with ratios of 1 part Ag to 100 parts Ti (or less). This was significantly lower than the silver:titania ratio in the starting sol (1:10). End-on SEM studies were also carried out to measure the thickness of the films. The two coat materials had a thickness of approximately 150 nm and a four coat material was approximately twice this thickness, at ca. 300 nm.

XPS

X-ray photoelectron spectroscopy (XPS) measurements were carried out on a VG ESALAB 220i XL instrument using focussed (300 μm spot) monochromatic Al-k_{α} X-ray radiation at a pass energy of 20 eV. Scans were acquired with steps of 50 meV. A flood gun was used to control charging and the binding energies were referenced to surface elemental carbon at 284.6 eV. Depth profile analysis was undertaken using argon sputtering.

X-ray photoelectron spectroscopy was undertaken on two sets of four coat Ag-TiO₂ films, one set exposed to UV light and one on the films as made. Both gave the same XPS profile. The titanium to oxygen atomic ratio was, as expected, 2:1 and no further elements were detected other than carbon and silicon at a few atom %. The percentage of the carbon decreased dramatically on etching indicating that it was residual carbon from within the XPS chamber. The Si abundance was constant with etching and probably a result of breakthrough to the underlying glass on regions where there was a small crack in the titania coating, notably it was only seen in one of the four samples analysed. Silver was detected both at the surface and throughout the film and its abundance was invariant with sputter depth. The silver was typically detected at below 1 atom %—significantly lower than that in the initial sol but comparable to that observed by WDX analysis (values ranged around 0.2 atom %, however accurate quantification was difficult at such low levels). The detection limit of the instrument is approximately 0.1 atom % and for quantification it is 0.2 atom %. XPS spectra were collected and referenced to elemental standards. The Ti 2p_{3/2} and O 1s binding energy shifts of 458.6 eV and 530.1 eV match exactly literature values for TiO₂.¹ In the sample exposed to UV light just prior to measurement there was a small shoulder to both the Ti and O peaks that correspond to Ti₂O₃. Interestingly the silver 3d_{5/2} XPS showed a single environment centred at 367.8 eV which gave a best match for Ag₂O (literature reports at 367.7-367.9 eV) rather than for silver metal 368.3 eV.¹ Hence the XPS is consistent with the silver being oxidised as Ag(I) rather than a metallic form in the thin films. Furthermore sputtering studies showed no change in the silver environment with sputter depth. This indicates that the silver is present as Ag₂O and not as a Ag₂O coated Ag particle; as otherwise an asymmetry to the peak shape would have occurred. ¹ NIST X-ray Photoelectron Spectroscopy Database. http://srdata.nist.gov/xps/ (Oct. 1, 2006).

XANES

X-ray absorption near edge structure (XANES) measurements were made on station 9.3 at the CCLRC Daresbury Synchrotron Radiation Source. The synchrotron has an electron energy of 2 GeV and the average current during the measurements was 150 mA. Ag K edge extended X-ray absorption fine structure (EXAFS) spectra for the films were collected at room temperature in fluorescence mode using ten films added together to give effectively 20 layers of the sample. Ag₂O, AgO, and Ag metal powder were used as standards, along with a Ag metal foil reference, and spectra were collected in standard transmission mode. The standards were prepared by thoroughly mixing the ground material with powdered polyvinylpyrrolidine diluent and pressing into pellets in a 13 mm IR press. Spectra were typically collected to k=16 Å⁻¹ and several scans were taken to improve the signal-to-noise ratio. For these measurements the amount of sample in the pellet was adjusted to give an adsorption of about μd=1. The data were processed in the conventional manner using the Daresbury suite of EXAFS programmes; EXCALIB and EXBACK.^{2, 3} ²N. Binsted, J. W. Campbell, S. J. Gurman and P. C. Stephenson SERC Daresbury Program Library, 1992.³ N. Binsted EXCURV98: CCLRC Daresbury Laboratory computer program, 1998.

Ag K-edge XAS spectra were collected for the three Ag-doped TiO₂ films made from sols with Ag concentrations of 5%, 10% and 20%, Ag metal foil, Ag metal powder, Ag₂O and AgO powders. A plot of the Ag K-edge XANES data for the doped samples along with the corresponding data for Ag metal powder, Ag₂O and AgO, in which the energy scales of all the spectra were consistently normalised to the Ag K-edge at 25518 eV and the spectra shifted on the y-axis for ease of viewing, shows that the local environment of the Ag atoms has a distinct effect on the shape of the XANES spectra. This can be used to identify the local environment of the Ag atoms in the Ag-doped TiO₂ films. In each case, the shape of the XANES spectra for the doped films matches that of the Ag₂O standard, indicating that the silver is present in the films as Ag₂O. The pattern for silver metal is very different to that observed and can't be detected in the samples measured. No bands were observed before the edge in any of the XANES experiments. Furthermore as the XAS gave such a good match to Ag₂O it is unlikely that the silver is present within the titania lattice as a discrete solid solution AgₓTi₂₋ₓO₂ because this would give a different edge shape pattern. Hence the films are best described as composites of anatase titania with small amounts of homogeneously distributed silver (I) oxide.

### Example 3

### Antimicrobial Function Under White Light

The antimicrobial functional properties of the thin films were assessed under illumination by a compact fluorescent lamp (herein described as white light source). The light source was a General Electric 28W Biax™ 2D™ lamp with a colour temperature of 4000K (cool white), General Electric part no: F282DT5/840/4P. This light source was chosen as it has the same characteristics as fluorescent lights used in hospitals in the United Kingdom.⁴ The spectral profile of the lamp consists of peaks at approximately 405, 435, 495, 545, 588, and 610 nm. The design of the lamp tubes minimises output of ultraviolet radiation, with only a small proportion of UV A and virtually no UV B or UV C radiation being produced by the lamp.⁵ The lamp's irradiance at a distance of 20 cm is less than 1×10⁻⁵ W/cm² (1×10⁻⁸ mW/cm²)⁵ at a wavelength of 365 um. This is less than the sun's irradiance measured on a cloudy day which is of the order 0.4 mW/cm² (4×10⁻⁴ W/cm²). ⁴ V. Decraene, J. Pratten and M. Wilson, App. Environ. Microbiol., 2006, 72, 4436.⁵ General Electric Company Biax™2D™ Lamps Technical Datasheet v1.6; 2005.

The antimicrobial functional assessment was carried out in the same manner as previously detailed for the coatings under ultraviolet light—the sole change in the experimental procedure was the change of the light source from 365 nm black light to the compact fluorescent white light source. TiO₂ controls and coatings derived from sols with Ag:Ti ratios of 5% and 10% were examined by this method. The coating derived from a 10% Ag:Ti solution was considerably more active under white light illumination than either the control or the 5% derived coating when illuminated for a six hour period. A numerical summary of the results is shown in Table 6.

TABLE 6
White light photokilling of S. aureus (NCTC 6571) by TiO₂
thin films in a 6 hour illumination period

| | S. aureus (NCTC | Log₁₀ | |
|---|---|---|---|
| Sample | 6571) cfu/ml | Kill | % Kill |
| TiO₂ Control (L+S+) | 7.71 × 10⁵ | 1.44 | 96.402 |
| Negative Control (L−S−) | 2.14 × 10⁷ | | |
| Ag₂O/TiO₂ from 5% sol | 2.88 × 10⁵ | 1.87 | 98.656 |
| (L+S+) | | | |
| Negative Control (L−S−) | 2.14 × 10⁷ | | |
| Ag₂O/TiO₂ from 10% sol | 4.02 × 10³ | 4.02 | 99.991 |
| (L+S+) | | | |
| Negative Control (L−S−) | 4.25 × 10⁷ | | |

### Example 4

It was noted in Example 3 that the active coating from 10% sol in the dark (L−S+) has a demonstrable killing effect. This was examined in detail by supplementary experiments. This was done to determine if the kill by this sample was due to latent photoactivity lingering after the pre-irradiation, or due to another factor, such as Ag⁺ ion diffusion from the surface. The experiment was designed to examine only the L−S+ and L−S− samples, which were left in the dark in a sterile Petri dish for 48 hours after the pre-activation/sterilising step. The experiment was otherwise conducted in exactly the same manner as the experiments under the white light source. Numerical data for this experiment is given below in Table 7.

TABLE 7
Killing of S. aureus (NCTC 6571) [coatings left
for 48 hrs in the dark prior to inoculation]

| | S. aureus (NCTC | Log₁₀ | |
|---|---|---|---|
| Sample | 6571) cfu/ml | Kill | % Kill |
| Ag₂O/TiO₂ from 10% sol | 3.72 × 10⁵ | 0.93 | 88.201 |
| (L−S+) | | | |
| Negative Control (L−S−) | 3.16 × 10⁶ | | |

The Ag₂O/TiO₂ coating demonstrates a kill of nearly one log unit in the dark. Since any latent photoactivity of the films would have been lost during the 48 hours of darkness, the microbicidal effect is most probably a result of Ag⁺ ion diffusion produced by Ag₂O nanoparticles which were observed randomly dispersed across the coating surface under SEM. This effect is a potential benefit, since the coatings will continue to be microbicidally active during spells of darkness and the dependency on white/black light illumination is reduced. The level of disinfection is lower than when illuminated as presumably only one microbicidal pathway is in operation. Disinfection is then enhanced by exposure to the white light source as both a photocatalytic and Ag⁺ ion microbicidal pathway would be in operation. Further experiments may need to be carried out to determine if Ag⁺ ions are the cause of the L−S+ killing effect for these films.

1. A film consisting of a titanium dioxide host matrix comprising silver oxide nanoparticles.

2. A film according to claim 1, wherein the film comprises 5% of the silver oxide nanoparticles by weight of the titanium dioxide host matrix.

3. A process of producing a film according to claim 1, comprising depositing silver metal or silver alloy nanoparticles and a titanium dioxide film under conditions in which the silver is oxidised.

4. A process of producing a film according to claim 1, comprising depositing silver oxide nanoparticles and a titanium oxide film.

5. Use of a film according to claim 1 as an antimicrobial.

6. Use according to claim 5, wherein the film is exposed to a radiation having a wavelength or wavelengths less than or equal to the band gap of the titanium dioxide in the film.

7. A substrate having a film according to claim 1 coated thereon.

8. Substrate according to claim 7, wherein the substrate comprises glass, metal, metal oxide, nitride, carbide, suicide or ceramic.

9. Substrate according to claim 7, wherein the substrate comprises medical equipment or instruments.

10. Substrate according to claim 7, wherein the substrate comprises a tile, work surface, door handle, tap or bed.
